(19) United States
(12) Patent Application Publication
(10) Pub. No.: US 2016/0198906 A1
(43) Pub. Date: Jul. 14, 2016

(54) CONTAINER WITH MIXING BLADE

(71) Applicant: DryBev International, Inc., Charlestown (KN)

(72) Inventor: Theodore Casey, Dallas, TX (US)

(21) Appl. No.: 14/874,853

(22) Filed: Oct. 5, 2015

Related U.S. Application Data
(63) Continuation-in-part of application No. 14/593,748, filed on Jan. 9, 2015.
Application No. 14/593,748 is a continuation-in-part of application No. 14/593,763, filed on Jan. 9, 2015.
Application No. 14/593,763 is a continuation-in-part of application No. 14/593,771, filed on Jan. 9, 2015.
Application No. 14/593,771 is a continuation-in-part of application No. 14/593,788, filed on Jan. 9, 2015.

(51) Int. Cl. A47J 43/27

(52) U.S. Cl. CPC A47J 43/27

(57) ABSTRACT

A container system for separately storing and mixing two or more substances. The container system comprises a mixing container having a main container that stores one or more first substances. The main container has a first upper opening. The container system also includes a storage repository coupled to main container, and which stores one or more second substances. The storage repository includes a lip defining a second upper opening, which has an outside diameter smaller than the diameter of the first upper opening. Additionally, the container system includes a mixing blade having an outside diameter smaller than the diameter of the first upper opening. The mixing blade also has a plurality of openings and a non-vertical wall portion adjacent said plurality of openings. The container system includes a releasable liner placed over the storage repository's lip, and the storage repository's lip forms a seal with a lower surface of the releasable liner.

### CROSS-REFERENCE TO RELATED APPLICATIONS

This application is a continuation-in-part of, and claims priority to, U.S. Non-Provisional patent application Ser. No. 14/593,748 entitled “CONTAINER WITH MIXING BLADE” filed on Jan. 9, 2015; U.S. Non-Provisional patent application Ser. No. 14/593,763 entitled “CONTAINER WITH MIXING BLADE” filed on Jan. 9, 2015; U.S. Non-Provisional patent application Ser. No. 14/593,771 entitled “CONTAINER WITH MIXING BLADE” filed on Jan. 9, 2015; and U.S. Non-Provisional patent application Ser. No. 14/593,788 entitled “CONTAINER WITH MIXING BLADE” filed on Jan. 9, 2015, all of which are incorporated by reference herein for all purposes.

### TECHNICAL FIELD

Disclosed herein is a method and system for separately storing and mixing two or more substances.

### DESCRIPTION OF RELATED ART

There exist prior art systems for separately storing and mixing two or more substances. Examples include the systems described in U.S. Pat. Nos. 6,059,443, 7,861,855 B2, 8,720,680 B2, and European Patent No. EP 2190751B1, the disclosures of which are incorporated by reference. Disclosed herein is an improved method and system for separately storing and mixing two or more substances.

### SUMMARY OF THE DISCLOSURE

In one aspect, what is disclosed herein is a container system. The container system includes a mixing container having a main container that stores one or more first substances. The main container has a first upper opening. The container system also includes a storage repository coupled to main container, and which stores one or more second substances. The storage repository includes a lip defining a second upper opening, which has an outside diameter smaller than the diameter of the first upper opening. Additionally, the container system includes a mixing blade having an outside diameter smaller than the diameter of the first upper opening and an inside diameter smaller than the outside diameter of the storage repository's lip. The mixing blade also has a plurality of openings. Furthermore, the container system includes a releasable liner placed over the storage repository's lip, and the storage repository's lip forms a seal with a lower surface of the releasable liner.

In another aspect, presently disclosed is a method of separately storing one or more first substances and one or more second substances, and mixing the substances at the time of usage of a product comprising a mixture of the substances. The method involves agitating the container system after removal of the releasable liner so that the one or more first substances and one or more second substances are permitted to mix with another.

### BRIEF DESCRIPTION OF THE DRAWINGS

The disclosure will be better understood and its numerous objects and advantages will become more apparent to those skilled in the art by reference to the following drawings, in conjunction with the accompanying specification, in which:

FIG. 1 is an exploded perspective view of a preferred embodiment of the container system of the present disclosure;

FIG. 1A is an exploded perspective view of an alternative embodiment of the container system of the present disclosure;

FIG. 2 is a perspective view of a preferred embodiment of the container system of the present disclosure with the storage repository covered by a releasable liner;

FIG. 3 is a perspective view of a preferred embodiment of the container system of the present disclosure showing the releasable liner being released;

FIG. 4 is a view of the container system showing the container system being agitated so that the one or more first substances and one or more second substances are mixed;

FIG. 5 is an exploded, front elevational, cross-sectional view of a preferred embodiment of the container system of the present disclosure;

FIG. 6 is a front elevational, cross-sectional view of a preferred embodiment of the container system of the present disclosure with the releasable liner placed over the storage repository;

FIG. 7 is a front elevational, cross-sectional view of a preferred embodiment of the container system of the present disclosure with the releasable liner removed;

FIG. 8A is a top, or overhead, view of the storage repository of a preferred embodiment of the container system of the present disclosure;

FIG. 8B is a perspective view of the storage repository of a preferred embodiment of the container system of the present disclosure;

FIG. 9 is an exploded, front elevational, cross-sectional view of an alternative preferred embodiment of the container system of the present disclosure;

FIG. 10 is a front elevational, cross-sectional view of the alternative preferred embodiment of the container system of the present disclosure with the releasable liner placed over the storage repository;

FIG. 11 is a front elevational, cross-sectional view of the alternative preferred embodiment of the container system of the present disclosure with the releasable liner removed; and

FIG. 12 is a side, cross-sectional, perspective view of an alternative mixing blade coupled to the cap of the alternative preferred embodiment of the container system of the present disclosure.

### DETAILED DESCRIPTION OF EMBODIMENTS

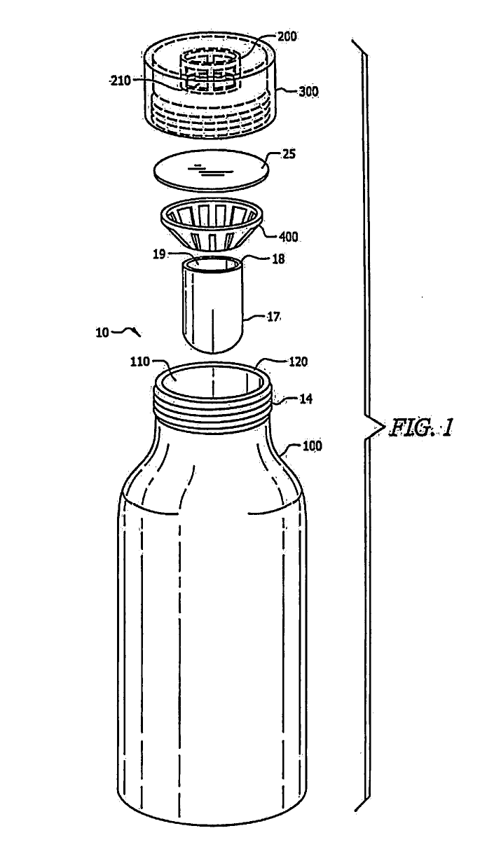

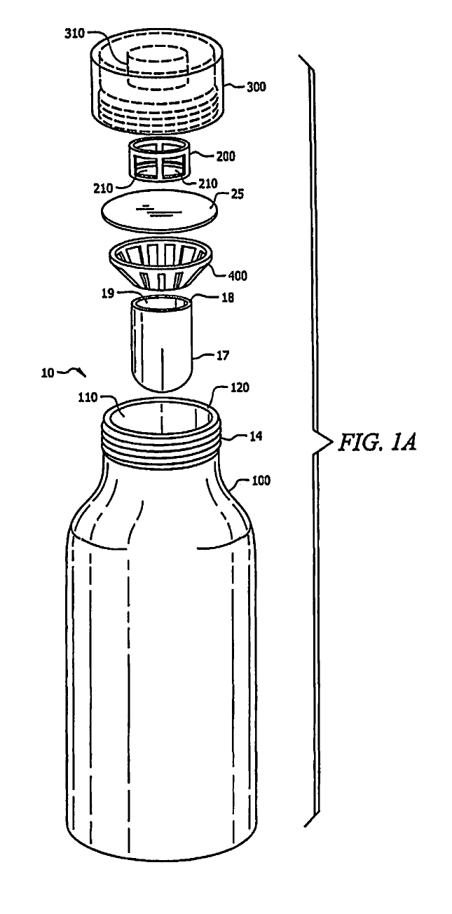

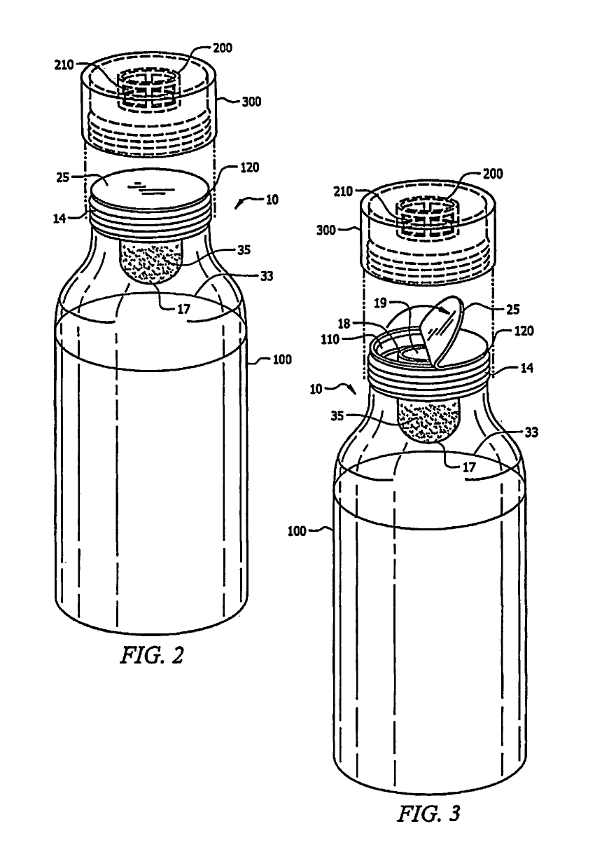

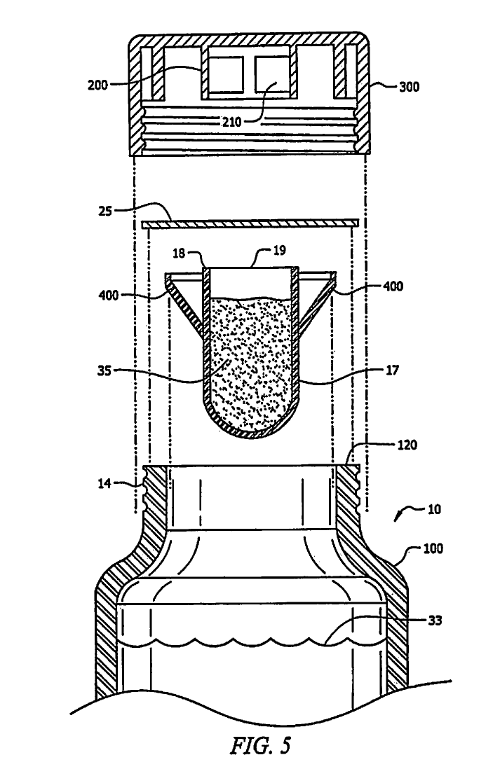

Referring to FIGS. 1-7, a preferred storage and mixing container 10 comprises a bottle 100 for containing one or more first substances, such as a liquid 33, a storage repository 17 for containing one or more second substances, such as a powder 35. The storage repository 17 is disposed within an upper opening 110 of the bottle 100 and coupled to the neck 120 of the bottle 100. This preferred embodiment includes a releasable liner 25 to cover a second upper opening 19 of the storage repository 17 when the container 10 is used to separately store the powder 35 from the liquid 33, and a cap 300 including a mixing blade 200 that couples to the bottle 100, such as by threads 14.

As depicted in FIGS. 1-3 and FIGS. 5-6, the cap 300 may comprise an element 200, sometimes referred to as a mixing blade, which is generally centrally located within the interior of the cap 300. As shown, the element 200 may be generally ring-shaped and have substantially the same diameter as the lip 18 defining an upper opening to the storage repository 17. Further, the element 200 may comprise ports 210 through the walls thereof. One of ordinary skill in the art will appreciate element 200 can be implemented in shapes other than circular shapes, such as a square, rectangle, pentagon, and the like; if non-circular shapes are used for element 200, lip 18 should be formed so that it generally matches the non-circular shape of and has the same perimeter as element 200.

In various implementations, the element 200 may be formed integrally within the cap 300, as shown in FIG. 1, or the element 200 may be formed separately from the cap 300 and secured within a ring 310 disposed in cap 300, as shown in FIG. 1A. In the implementation of FIG. 1A, the element 200 may be secured within the ring 310 via interference fit and/or otherwise coupled to the cap 300 adhesively, mechanically, magnetically or by other means that will be apparent to one of ordinary skill in the art.

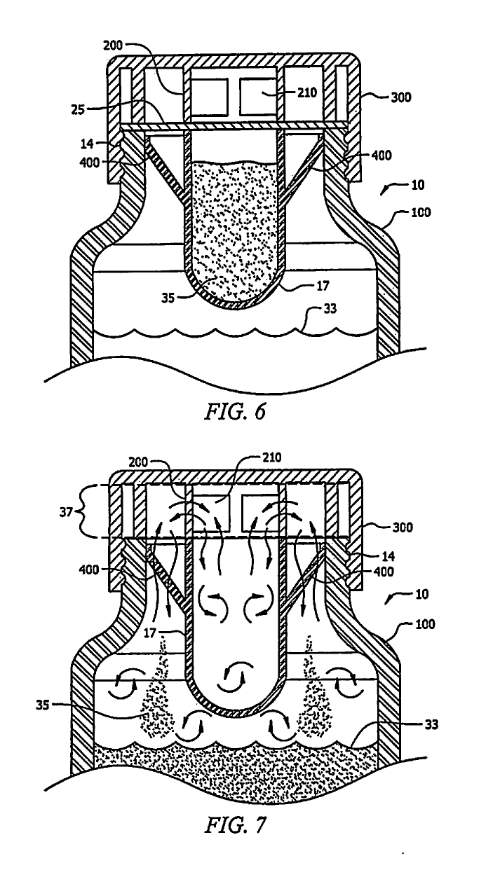

As depicted in FIGS. 1 and 1A, the container system includes one or more couplings 400 used so that the storage repository 17 will be disposed within an upper opening of the bottle 100 and coupled to the neck 120 of the bottle 100. Disposition of the storage repository 17 within the bottle 100 is depicted in FIGS. 6 and 7.

As depicted in FIG. 6, when the cap 300 is coupled to the bottle 100 while the releasable liner 25 is present, and the mixing blade 200 is contacting an upper surface of the releasable liner 25, a seal is formed between a lower surface of the releasable liner 25 and the lip 18 of the storage repository 17. The seal prevents the one or more first substances 33 from mixing with the one or more second substances 35. As shown in FIG. 6, the cap 300 is coupled to the bottle 100 using threads, but one of ordinary skill in the art will appreciate any number of other means can be used to couple cap 300 to bottle 100.

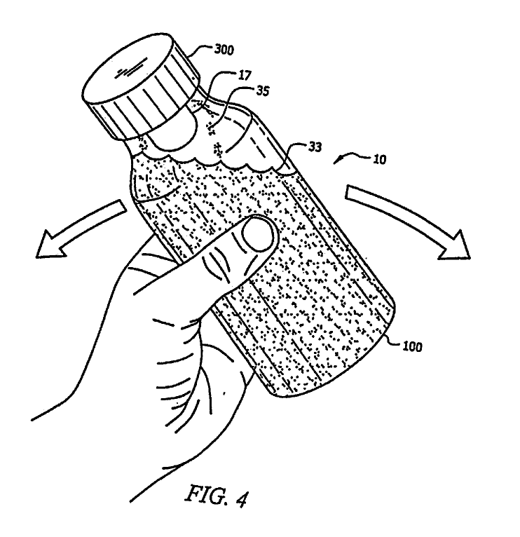

FIG. 7 depicts the container system when the releasable liner 25 has been removed. A gap 37 is provided, comprising space above the one or more couplings, continuing above the upper opening 110 of the bottle 100, and below an interior surface of the top of the cap 300, through ports 210, and into additional open space inside mixing blade 200. The gap 37 provides additional space to facilitate mixing of liquid 33 and powder 35. When releasable liner 25 has been removed, liquid 33 may move between the bottle 100, gap 37, and storage repository 17 by passing around the one or more couplings 400 and through the one or more ports 210 of the mixing blade 200. Likewise, when releasable liner 25 has been removed, powder 35, may move between the storage repository 17, gap 37, and the bottle 100 by passing through ports 210 of the mixing blade 200 and the one or more couplings 400. Such mixing is depicted in FIG. 7, and occurs when, for example, the bottle 100 is shaken, inverted, or otherwise agitated, one example of such agitation being depicted in FIG. 4.

In a preferred embodiment, as depicted in FIGS. 6 and 7, mixing blade 200 may have substantially the same height as the height of the space created between the upper opening 110 of the bottle 100 and the interior surface of the top of the cap 300, and the diameter of the mixing blade may have substantially the same diameter as the diameter of the lip 18 of the storage repository 17. One of ordinary skill in the art will appreciate that mixing blade 200 can be designed with ports 210 having virtually any shape, including polygonal shapes such as rectangles, squares, and triangles, or curved shapes, such as circles. Also, the number of ports 210 that may be used is not limited to the number depicted in FIGS. 1-3.

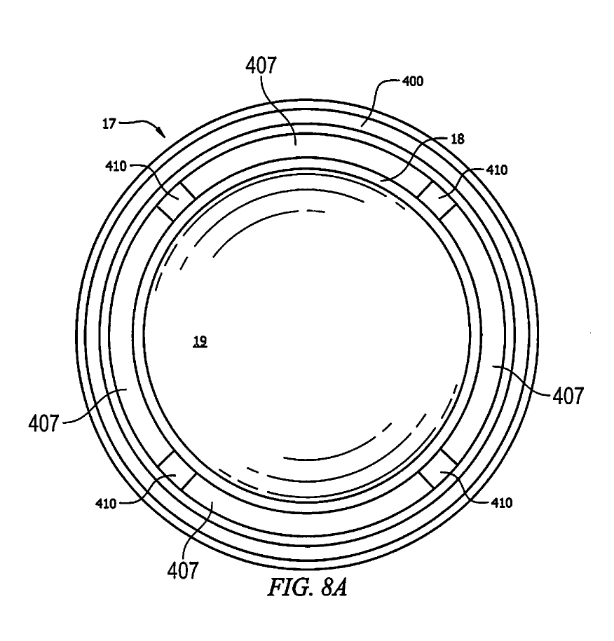

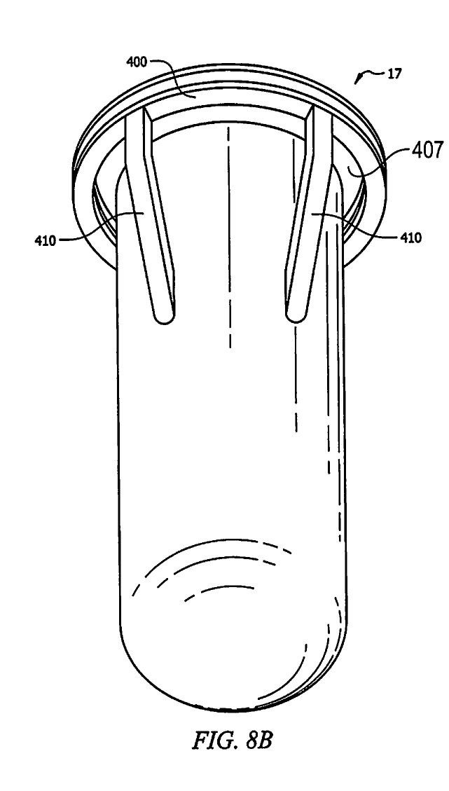

While the one or more couplings 400 may not be designed so that the one or more first substances and one or more second substances are completely prevented from moving between the bottle 100 and storage repository 17, one of ordinary skill in the art will appreciate that various couplings may be used to couple the storage repository 17 to the neck 110 of bottle 100. Couplings 400 may consist of a single piece of material having ports through which the one or more first and second substances may move, or, as depicted in FIGS. 8A and 8B, multiple pieces of material, such as support arms 410, that are placed apart from one another to create space 407 through which the one or more first and second substances may move. Also, couplings 400 may be manufactured as one piece with the storage repository 17 or bottle 100, or may be separate components.

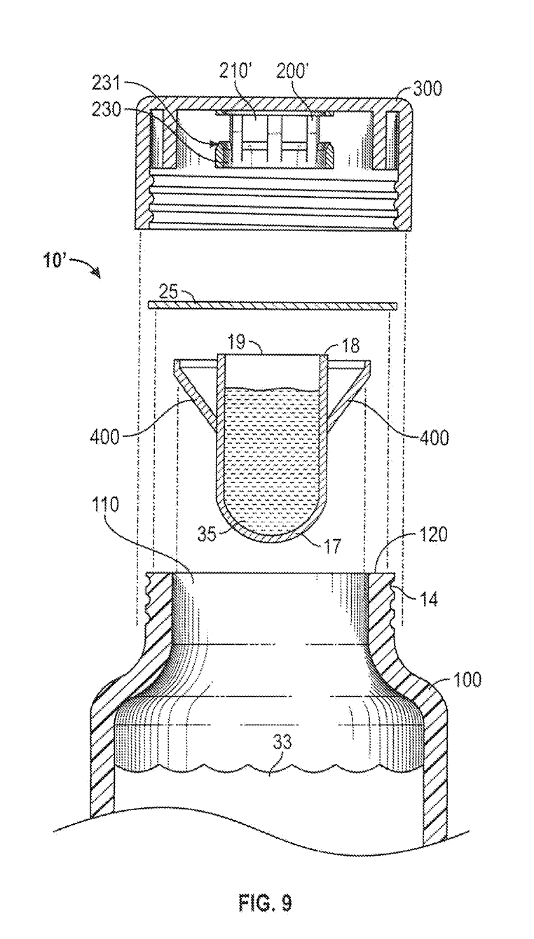

Referring to FIGS. 9-11, wherein like reference numerals correspond to like components, another alternative preferred storage and mixing container 10′ is depicted comprising an alternative element 200′, sometimes referred to as an alternative mixing blade. The alternative element 200′ comprises one or more ports 210′ extending through the walls thereof. The alternative element 200′ further comprises a lower portion 230 that extends into a non-vertical wall portion 231 formed adjacent to the ports 210′ and providing a lower boundary to the ports 210′. As used herein, the term non-vertical means not perpendicular to the plane defined by upper opening 110 of the bottle 100. One of ordinary skill in the art will appreciate that a non-vertical wall portion can be formed into a variety of linear or curved shapes, or a combination of different shapes.

The alternative element 200′ may be generally centrally located within the interior of the cap 300 of the alternative container 10′. Similar to element 200 shown in FIGS. 1-7, the alternative element 200′ may be generally ring-shaped and have substantially the same diameter as the lip 18 defining an upper opening to the storage repository 17. One of ordinary skill in the art will appreciate that the alternative element 200′ can be implemented in shapes other than circular shapes, such as a square, rectangle, pentagon, and the like; if non-circular shapes are used for alternative element 200′, then lip 18 of the alternative container 10′ should be formed so that it generally matches the non-circular shape of and has the same perimeter as alternative element 200′.

In various implementations, the alternative element 200′ may be formed integrally within the cap 300, as shown in FIG. 1, or the alternative element 200′ may be formed separately from the cap 300 and secured within a ring 310 disposed in the cap 300, as shown in FIG. 1A. The alternative element 200′ may be secured within the ring 310 via interference fit and/or otherwise coupled to the cap 300 adhesively, mechanically, magnetically or by other means that will be apparent to one of ordinary skill in the art.

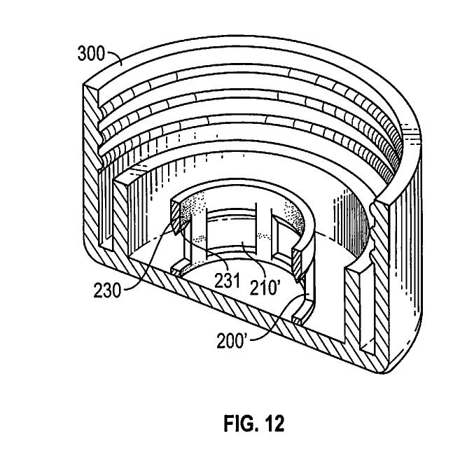

FIG. 12 depicts a side, cross-sectional, perspective view of the cap 300 with the alternative element 200′ coupled thereto. As depicted in FIG. 9-12, each of the substantially vertical wall portion 230 and the non-vertical wall portion 231 of the alternative element 200′ comprises opposing sides. The opposing sides of the substantially vertical wall portion 230 may be substantially parallel to each other and substantially perpendicular to the lip 18 of the alternative container 10′. At least one of the opposing sides of the non-vertical wall portion 231 may be tapered so as to extend at an angle from the corresponding side of the substantially vertical wall portion 230 toward the other opposing side of the non-vertical wall portion 231. If both opposing sides of the non-vertical wall portion 231 are tapered, they may extend toward each other at substantially the same angle or at different angles from the corresponding side of the substantially vertical wall portion 230. As shown, the opposing sides of the non-vertical wall portion 231 may terminate substantially at a point adjacent to the ports 210′.

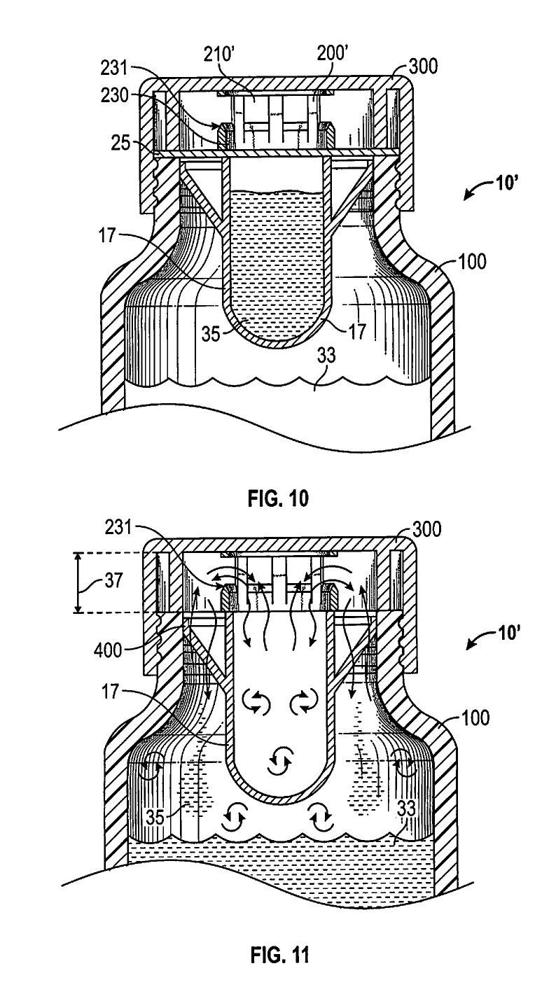

As depicted in FIG. 10, when the cap 300 is coupled to the bottle 100 while the releasable liner 25 is present, and the mixing blade 200′ is contacting an upper surface of the releasable liner 25, a seal is formed between a lower surface of the releasable liner 25 and the lip 18 of the storage repository 17. The seal prevents the one or more first substances 33 from mixing with the one or more second substances 35.

FIG. 11 depicts the container system when the releasable liner 25 has been removed. A gap 37 is provided, comprising space above the one or more couplings, continuing above the upper opening 110 of the bottle 100, and below an interior surface of the top of the cap 300, through ports 210′, and into additional open space inside alternative mixing blade 200′. The gap 37 provides additional space to facilitate mixing of liquid 33 and powder 35. When releasable liner 25 has been removed, liquid 33 may move between the bottle 100, gap 37, and storage repository 17 by passing around the one or more couplings 400 and through ports 210′ of the alternative mixing blade 200′. Likewise, when releasable liner 25 has been removed, powder 35 may move between the storage repository 17, gap 37, and the bottle 100 by passing through ports 210′ of the alternative mixing blade 200′ and the one or more couplings 400.

As shown in FIG. 11, such mixing occurs when, for example, the bottle 100 is shaken, inverted, or otherwise agitated, one example of such agitation being depicted in FIG. 4. During such mixing, the non-vertical surface 231 of the alternative mixing blade 200′ may inhibit or prevent the build-up of powder 35, or any other second substance, on the alternative mixing blade 200′ and may further enhance mixing as powder 35 moves from the storage repository 17 and through the ports 210′ of the alternative mixing blade 200′.

As depicted in FIGS. 9-11, the alternative mixing blade 200′ may have substantially the same height as the height of the space created between the upper opening 110 of the bottle 100 and the interior surface of the top of the cap 300, and the diameter of the alternative mixing blade 200′ may have substantially the same diameter as the diameter of the lip 18 of the storage repository 17. One of ordinary skill in the art will appreciate that the alternative mixing blade 200′ can be designed with ports 210′ having virtually any shape, including polygonal shapes such as rectangles, squares, and triangles, or curved shapes, such as circles. Also, the number of ports 210′ that may be used is not limited to the number depicted in FIGS. 1-12.

The one or more first substances and the one or more second substances may each be in solid form, liquid form, or some combination thereof. Examples of substances that may be used in connection with the container system include but are not limited to the following substances: water, dehydrated substances, preservative free substances, dietary supplement mixtures, nutritional mixtures, protein mixtures, dairy based proteins, milk proteins, whey proteins, vegetable based proteins, soy based proteins, amino-acids, beta alanine, vitamins, minerals, creatine, glutamine, L-arginine, phenylalanine, L-Leucine, L-Isoleucine, L-yaline, Synephrine, yohimbe, ginseng, ascorbic acid, hydroxyl citric acid, aloe vera, dimethylamyamine, polysaccharide, monosaccharide, maltodextrin, dextrose, fructose, silicon, artificial sweeteners, natural sweeteners, sucralose, artificial or natural flavors, artificial or natural colors, tea, coffee, dairy product, or any other substances which may be consumed by a user either alone, or in combination with any other chemical or other substance.

The bottle 100 and storage repository 17 may be constructed of any material suitable for storing liquid or solid substances. In a preferred embodiment, the bottle 100 is manufactured of polyethylene terephthalate (PET). One of ordinary skill in the art will appreciate that other materials also could be used to manufacture said bottle 100 or storage repository 17, such as other plastics (including High Density Polyethylene and polypropylene), glass, metal, styrofoam and the like. It is contemplated that alternate embodiments of the container system may be constructed of materials suitable for heating within a microwave oven or other heating apparatus. Cap 300, mixing blade 200, alternative mixing blade 200′, and the one or more couplings 400 may likewise be constructed of any suitable materials, including those identified above.

The purpose of releasable liner 25 is to prevent the mixing of the one or more first substances and the one or more second substances. One of ordinary skill in the art will therefore appreciate releasable liner 25 can be implemented in the container system of the present disclosure in many different ways. Releasable liner 25 may cover first upper opening 110 of the bottle 100 and the second upper opening 19 of storage repository 17, but one of ordinary skill in the art will appreciate releasable liner 25 need only cover second upper opening 19. Releasable liner 25 may be a gasket, i.e., it may be loosely placed over second upper opening 19 in the absence of cap 300 being placed on bottle 100, so that the releasable liner 25 might fall off when cap 300 is removed. Or, releasable liner 25 might be coupled to bottle 100 and/or lip 18 using an adhesive. Releasable liner 25 could even be formed in the shape of a sphere, such as a marble, or a spherical cone, and be disposed in second upper opening 19 of storage repository 17.

It is believed the operation and construction of the apparatus and method disclosed herein will be apparent from the foregoing description. While the apparatus and method shown and described has been characterized as being preferred, it will be readily apparent that various changes and modifications could be made without departing from the spirit and scope of the disclosure.

1. A container system for mixing two or more substances comprising:
(a) a main container for holding one or more first substances, said main container having a first upper opening;
(b) a storage repository for holding one or more second substances, said storage repository positioned within and coupled to said main container, and including a lip defining a second upper opening, said lip having an outside diameter smaller than a diameter of the first upper opening;
(c) a mixing blade, said mixing blade having an outside diameter smaller than the diameter of the first upper opening and an inside diameter smaller than the outside diameter of said lip, said mixing blade having a plurality of openings and a non-vertical wall portion adjacent said plurality of openings; and
(d) a releasable liner covering said second upper opening;
(e) wherein said lip forms a seal with a lower surface of said releasable liner.

2. The container system of claim 1, wherein at least a portion of said mixing blade contacts said lip after said releasable liner is removed.

3. The container systems of claim 1, wherein no portion of said mixing blade contacts said lip after said releasable liner is removed.

4. The container system of claim 1, wherein said first upper opening is formed in a neck of said main container.

5. The container system of claim 1, further comprising: a releasable cap coupled to an outer surface of said neck and having an upper inner surface covering said first upper opening, wherein said mixing blade is coupled to said upper inner surface of said releasable cap.

6. The container system of claim 1, further comprising: a releasable cap coupled to an outer surface of said main container and having an upper inner surface covering said first upper opening, wherein said mixing blade is integrally formed into said upper inner surface of said releasable cap.

7. The container system of claim 1, wherein said storage repository is coupled to said main container by one or more couplings.

8. The container system of claim 7, wherein said one or more couplings comprise a single component surrounding said storage repository, said single component having ports therethrough.

9. The container system of claim 7, wherein said one or more couplings comprise a plurality of support arms spaced apart around said storage repository.

10. The container system of claim 1, wherein said second upper opening is substantially parallel to said first upper opening.

11. The container system of claim 1, wherein said releasable liner is a gasket placed loosely over second upper opening and engaging said lip.

12. The container system of claim 1, wherein said releasable liner is sealed to said lip with an adhesive.

13. The container system of claim 1, wherein said releasable liner is spherical or conical and is disposed in said second upper opening.

14. A container system for mixing two or more substances comprising:
(a) a main container for holding one or more first substances;
(b) a storage repository for holding one or more second substances, said storage repository coupled within said main container by one or more couplings;
(c) a releasable liner for closing said storage repository to prevent said second substances from mixing with said first substances; and
(d) a mixing blade having a plurality of openings and a non-vertical wall portion adjacent said plurality of openings.

15. The container system of claim 14, wherein said plurality of openings in said mixing blade aid in mixing said second substances with said first substances when said releasable liner is removed to open said storage repository and said container system is shaken.

16. The container system of claim 14, wherein said one or more couplings form openings that aid in mixing said second substances with said first substances when said releasable liner is removed to open said storage repository and said container system is shaken.

17. The container system of claim 14, further comprising a releasable cap that couples to said main container and positions said mixing blade to contact said upper surface of said releasable liner.

18. The container system of claim 17, wherein said releasable liner falls off to open said storage repository when said releasable cap is removed.

19. The container system of claim 17, wherein said releasable liner is selectively releasable to open said storage repository when said releasable cap is removed.

20. The container system of claim 1, wherein said non-vertical wall portion has at least one tapered side extending at an angle from a corresponding side of a substantially vertical wall portion of the mixing blade.

21. The container system of claim 1, wherein said non-vertical wall portion has two tapered sides, each of the two tapered sides extending toward each other at an angle from two corresponding sides of a substantially vertical wall portion of the mixing blade.

22. The container system of claim 21, wherein said two tapered sides extend toward each other at substantially the same angle from said two corresponding sides of the substantially vertical wall portion of the mixing blade.

23. The container system of claim 21, wherein said two tapered sides extend toward each other at different angles from said two corresponding sides of the substantially vertical wall portion of the mixing blade.

24. The container system of claim 21, wherein said two tapered sides terminate substantially at a point adjacent said plurality of openings.

25. The container system of claim 14, wherein said non-vertical wall portion adjacent said plurality of openings in said mixing blade inhibits build-up of said first or second substances on said mixing blade when said releasable liner is removed to open said storage repository and said container system is shaken.

26. The container system of claim 14, wherein said non-vertical wall portion adjacent said plurality of openings in said mixing blade aids in mixing said second substances with said first substances when said releasable liner is removed to open said storage repository and said container system is shaken.
